(19) United States
(12) Patent Application Publication
(10) Pub. No.: US 2023/0172234 A1
(43) Pub. Date: Jun. 8, 2023

(54) JELLIFIED WET FOOD PRODUCTS AND METHODS FOR PREPARING THE SAME

(71) Applicants: MARS, INCORPORATED, McLean, VA (US); GALEWPET, Ploermel (FR)

(72) Inventors: Thierry Six, Aimargues (FR); Hervé Gabillet, Ploermel (FR); Astrid Temmerman, Ploermel (FR)

(73) Assignees: MARS, INCORPORATED, McLean, VA (US); GALEWPET, Ploermel (FR)

(21) Appl. No.: 17/917,600

(22) PCT Filed: Apr. 7, 2021
(86) PCT No.: PCT/US2021/026229

§ 371 Date: Oct. 7, 2022

(30) Foreign Application Priority Data
Apr. 8, 2020 (EP) 20315132.9

(51) Int. Cl. A23K 50/48; A23K 20/147; A23K 20/158; A23K 20/163; A23L 29/256; A23L 33/115; A23L 33/17; A23L 33/125; A23L 21/10

(52) U.S. Cl. CPC A23K 50/48; A23K 20/147; A23K 20/158; A23K 20/163; A23L 29/256; A23L 33/115; A23L 33/17; A23L 33/125; A23L 21/10

(57) ABSTRACT

The presently disclosed subject matter provides methods of preparing wet food products, such as jellified wet food products. Methods include preparing a pre-gel mixture comprising a combination of food ingredients, one or more alginate, and an aqueous liquid; adding one or more organic acids to the pre-gel mixture to generate a jellified composition; and expulsing aqueous liquid within the jellified composition. The present disclosure further provides microbially stable wet food products prepared using such methods.

### CROSS-REFERENCE TO RELATED APPLICATIONS

This application claims the benefit of priority to EP Patent Application Serial No. 20315132.9, filed on Apr. 8, 2020, the contents of which are incorporated herein by reference in their entirety.

### 1. FIELD

The presently disclosed subject matter relates to wet food compositions, and in particular wet pet food compositions, which can be jellified and microbially stable and methods for preparing the same.

### 2. BACKGROUND

Pet food products provide a widespread means for feeding pets. In certain aspects, pet food can be categorized on the basis of its moisture content. For example, dry or low moisture content products (e.g., less than about 15%), wet or high moisture content products (e.g., greater than about 50%), and semi-moist or semi-dry or soft dry of intermediate or medium moisture content products (e.g., between about 15% and about 50%). Dry or low moisture content products can combine high nutritional content with convenience, whereas wet or high moisture content products are generally most palatable to pets.

Further, wet or high moisture content products can be characterized into two main types. The first type is a “paté” or “loaf” product, which can be prepared by processing a mixture of edible components under heat to produce a homogenous semi-solid mass that is structured by heat-coagulated protein. This homogenous mass can be packaged into single serve or multi-serve packaging which can then be sealed and heat sterilized. Upon packing, the homogenous mass can assume the shape of the container. The second type is a “chunk and gravy”, “chunk and jelly”, or “chunk and mousse” product, depending on the nature of the sauce component. The chunks can comprise meat pieces or restructured meat pieces. Restructured meat pieces can be prepared by making a meat emulsion containing a heat-settable component, and by applying thermal energy to “set” the emulsion and allow it to assume the desired shape, for example, after cutting. The product pieces can be combined with a sauce (e.g., gravy, jelly or mousse) in single serve or multi-serve packaging which can then be sealed and heat sterilized.

Heat sterilization of wet pet food products, including “paté”, “loaf”, and “chunk and gravy” products, can be a compulsory step since these meat-containing products can include a substantial bacterial load. Such sterilization step can ensure both microbiological stability and safety of the final wet pet food product. Heat sterilization can be performed at about 120° C. or higher, for example, in an autoclave apparatus.

However, heat sterilization can cause a substantial alteration or destruction of several ingredients of the wet pet food product, including vitamins and protein hydrolysates. The sterilization step can also affect nutrient bioavailability and palatability. For example, heat sterilization can affect the nutritional and organoleptic properties of food ingredients contained in the wet pet food product. Undesirable flavor compounds such as sulphur-containing thiazole and thiophene compounds can develop as a result of the occurrence of the Maillard reaction between free reactive amino groups of specific amino acids and reducing sugars.

Heat sterilization can also negatively influence palatability for cats, which can be attributed, for example, to the formation of lipid peroxides and/or more aroma-intensive heterocyclic Maillard reaction products, such as pyrrole, pyridine and pyrazine, providing undesirable flavors during retorting to occur (Heinicke, et al., 2003, in Pet Food Technology, JLKvamme and TD Philips Eds, Mount Morris, Ill.: Watt Publishing Co.: 183-186). This can lead to development of bitterness that can affect palatability although wet pet food products can be initially more palatable than dry pet food products and can contribute to the daily water intake of the animal by its moisture content. Heat sterilization can also lead to overcooking and undesirable textural characteristics of the wet pet food product, which can affect its binding properties. In certain aspects, texture can be related to palatability, for example, as chewiness, hardness and elasticity can affect mouth feel of food products. In order to partially overcome reduced palatability, one or more palatability enhancers can be added. However, the addition of palatability enhancers does not overcome the reduced nutrient bioavailability nor the potential health risks related to the presence of various undesirable Maillard reaction compounds present in heat sterilized wet pet food products.

Wet pet food products processed at lower temperatures, including when performing the sterilization step for a longer period of time, can be a partial technical solution as disclosed by Hagen-Plantinga, et al. (2017, Journal of Nutritional Science, Vol. 6: e23). However, milder sterilization conditions do not allow for manufacturing for wet pet food products that are sufficiently microbiologically stable.

Accordingly, there remains a need for methods of preparing wet food products, for example, wet pet food products, which are an alternative or improvement to the presently known methods of heat sterilization and that provide wet food products with antibacterial properties, high palatability, and a lack of undesirable products generated by the Maillard reaction. The presently disclosed subject matter addresses these and other needs.

### 3. SUMMARY OF THE INVENTION

The presently disclosed subject matter provides for methods of preparing wet food compositions, in particular wet pet food compositions, which can be jellified and microbially stable. Such methods do not require heat sterilization and advantageously provide wet food products with antibacterial properties, high palatability, and a lack of undesirable products generated by the Maillard reaction.

The present disclosure relates to a method for preparing a jellified wet food product comprising the steps of:

a) preparing a pre-gel mixture comprising a combination of food ingredients, one or more alginate, and an aqueous liquid;

b) adding one or more organic acids to the pre-gel mixture obtained at step a), so as to generate a jellified composition; and

c) subjecting the jellified composition obtained at step b) to a step of expulsing the aqueous liquid comprised therein,

whereby a jellified wet food product is provided.

In certain embodiments, the alginate can be a monocation alginate.

The present disclosure relates to a method for preparing a jellified wet food product comprising the steps of:

a) preparing a pre-gel mixture comprising a combination of food ingredients, one or more monocation alginate, and an aqueous liquid;

b) adding one or more organic acids to the pre-gel mixture obtained at step a), so as to generate a jellified composition; and

c) subjecting the jellified composition obtained at step b) to a step of expulsing the aqueous liquid comprised therein,

whereby a jellified wet food product is provided.

In certain embodiments, the method further comprises the steps of:

d) collecting the aqueous liquid expulsed at step c);

e) adding one or more thickening agents to the aqueous liquid collected at step d), so as to obtain an aqueous material of an increased viscosity; and

f) adding the aqueous material obtained at step e) to the jellified composition obtained at the end of step c), so as to provide a jellified wet food product.

In certain embodiments, the method comprises after step b) and before step c) an additional step of cutting the jellified composition obtained at step b) into pieces of a desired size.

In certain embodiments, the one or more alginate used at step a) are selected in the group comprising sodium alginate, potassium alginate, and ammonium alginate.

In certain embodiments, the temperature, for each step of the method, does not exceed about 40° C. In certain embodiments, the temperature, for each step of the method, ranges from about 10° C. to about 30° C.

In certain embodiments, the one or more organic acids used at step b) are selected in the group comprising Formic acid, Sorbic acid, Acetic acid, Lactic acid, Propionic acid, DL-Malic acid, Fumaric acid, Citric acid, Ascorbic acid, Phenylacetic acid, Butyric acid, 2-Methyl-2-pentenoic acid, Dec-2-enoic acid, Citronellic acid, L-Aspartic acid, L-Glutamic acid, Cinnamic acid, 2-Methylpropionic acid, 2-Methylcrotonic acid, Propionic acid, Valeric acid, 3-Methylbutyric acid, Hexanoic acid, Octanoic acid, Decanoic acid, Dodecanoic acid, Oleic acid, Hexadecanoic acid, Tetradecanoic acid, Benzoic acid, 4-Oxovaleric acid, Succinic acid, Fumaric acid, Heptanoic acid, Nonanoic acid, 2-Methylvaleric acid, 2-Ethylbutyric acid, 2-Methylbutyric acid, 2-Methylheptanoic acid, 4-Methylnonanoic acid, 4-Methyloctanoic acid, Gallic acid, Tannic acid, and Glucono-delta-lactone or in the group comprising Lactic acid, Citric acid, Gluconic acid, and Ascorbic acid.

In certain embodiments, at the end of step b), the jellified composition can have at a pH ranging from about 3 to about 4.6, or from about 3.5 to about 4.2.

In certain embodiments, the combination of food ingredients used at step a) comprise one or more thermo-sensitive substances selected in the group comprising vitamins, probiotics, prebiotics, hydrolysates, aroma, nutrients (such as taurine, green lipped mussel, chondroitin, collagen, polyphenols, flavonoids, curcuminoids, aloe vera extract, etc.), anti-oxidants, yeast, bacteria, amino acids, and fibers.

In certain embodiments, the pre-gel mixture of step a) comprises calcium at a final concentration of at least about 0.1%.

In certain embodiments, the pre-gel mixture of step a) further comprises one or more added sequestrant agents such as pyrophosphates, orthophosphates, polyphosphates, and citrates.

In certain embodiments, the combination of food ingredients used at step a) comprises protein, fat, and carbohydrate and wherein the protein content is of at most of about 5 to about 65 weight percent on a dry matter basis.

In certain embodiments, the pre-gel mixture is prepared following to the steps of:

a1) preparing a dry premix composition comprising food ingredients that can be under fresh form, frozen form, or dehydrated form, one or more molecule of interest, and one or more alginate; and

a2) mixing the dry premix composition prepared at step a1) with an aqueous liquid,

whereby a pre-gel mixture is provided.

In certain embodiments, the jellified wet food product which is obtained according to the disclosed method can be a jellified wet pet food product such as complete, complementary, treats.

In certain embodiments, the jellified wet food product which is obtained according to the disclosed method can be a jellified wet human food product.

The present disclosure further provides a microbiologically stable jellified wet food product comprising protein, fat, and carbohydrate which product has a moisture content ranging from about 50% to about 99%, wherein said wet food product comprises alginate in an amount ranging from about 0.1% to about 10% by weight, on a dry matter basis, and has a pH ranging from about 3 to about 4.6, or from about 3.5 to about 4.2.

In certain embodiments, the microbiologically stable jellified wet food product can be a two-parts product with one solid part having a gel hardness ranging from about 100 g to about 50,000 g and a liquid part having a viscosity ranging from about 2 centipoise to about 2,000 centipoise.

The present disclosure further provides a method of feeding a pet animal comprising a step of feeding a pet with a microbiologically stable jellified wet food product obtained by the method disclosed herein or with a microbiologically stable jellified wet food also disclosed herein.

The present disclosure provides methods for preparing a jellified wet food product. The method can include a) preparing a pre-gel mixture comprising a combination of food ingredients, one or more alginate, and an aqueous liquid; b) adding one or more organic acids to the pre-gel mixture to provide a jellified composition; and c) expulsing the aqueous liquid from the jellified composition, in which the jellified wet food product is provided.

In certain embodiments, the method can further include d) collecting the aqueous liquid expulsed at step c); e) adding one or more thickening agents to the aqueous liquid collected at step d) to provide an aqueous material having an increased viscosity; and f) adding the aqueous material obtained at step e) to the jellified composition obtained at the end of step c) to provide a jellified wet food product.

In certain embodiments, the method can further include cutting the jellified composition obtained at step b) into pieces of a desired size.

In certain embodiments, the one or more alginate can include one or more monocation alginate.

In certain embodiments, the one or more alginate can include sodium alginate, potassium alginate, ammonium alginate, and combinations thereof.

In certain embodiments, the temperature for each step of the method can be less than about 40° C. In particular embodiments, the temperature for each step of the method can be between about 10° C. and about 30° C.

In certain embodiments, the one or more organic acids comprise Formic acid, Sorbic acid, Acetic acid, Lactic acid, Propionic acid, DL-Malic acid, Fumaric acid, Citric acid, Ascorbic acid, Phenylacetic acid, Butyric acid, 2-Methyl-2-pentenoic acid, Dec-2-enoic acid, Citronellic acid, L-Aspartic acid, L-Glutamic acid, Cinnamic acid, 2-Methylpropionic acid, 2-Methylcrotonic acid, Propionic acid, Valeric acid, 3-Methylbutyric acid, Hexanoic acid, Octanoic acid, Decanoic acid, Dodecanoic acid, Oleic acid, Hexadecanoic acid, Tetradecanoic acid, Benzoic acid, 4-Oxovaleric acid, Succinic acid, Fumaric acid, Heptanoic acid, Nonanoic acid, 2-Methylvaleric acid, 2-Ethylbutyric acid, 2-Methylbutyric acid, 2-Methylheptanoic acid, 4-Methylnonanoic acid, 4-Methyloctanoic acid, Gallic acid, Tannic acid, Glucono-delta-lactone, and combinations thereof. In particular embodiments, the one or more organic acids comprise Lactic acid, Citric acid, Gluconic acid, Ascorbic acid, and combinations thereof.

In certain embodiments, at the end of step b), the jellified composition can have a pH of from about 3 to about 4.6. In particular embodiments, the jellified composition can have a pH of from about 3.5 to about 4.2.

In certain embodiments, the combination of food ingredients can include one or more thermo-sensitive substances including vitamins, probiotics, prebiotics, protein hydrolysates, aroma, nutrients, anti-oxidants, yeast or yeast extracts, bacteria, amino acids, fibers, and combinations thereof.

In certain embodiments, the pre-gel mixture can include calcium at a final concentration of at least about 0.1%.

In certain embodiments, the pre-gel mixture can further include one or more sequestrant agents. The one or more sequestrant agents can include pyrophosphates, orthophosphates, polyphosphates, citrates, and combinations thereof.

In certain embodiments, the combination of food ingredients can include protein, fat and carbohydrates, and the protein content of the combination of food ingredients can be from about 5% to about 65% by weight, on a dry matter basis.

In certain embodiments, the method can further include a method of preparing the pre-gel mixture, which can include a1) preparing a dry premix composition including food ingredients in fresh form, frozen form, or dehydrated form, one or more molecule of interest, and one or more alginate; and a2) mixing the dry premix composition with an aqueous liquid, in which the pre-gel mixture is provided.

In certain embodiments, the jellified wet food product can be a jellified wet pet food product.

In certain embodiments, the jellified wet food product can be a jellified wet human food product.

The present disclosure further provides methods for preparing a jellified wet food product. The method can include a) preparing a pre-gel mixture comprising a combination of food ingredients, one or more monocation alginate, and an aqueous liquid; b) adding one or more organic acids to the pre-gel mixture to provide a jellified composition; and c) expulsing the aqueous liquid from the jellified composition, in which the jellified wet food product is provided.

The present disclosure further provides microbiologically stable jellified wet food products. The microbiologically stable jellified wet food produce can include protein, fat and carbohydrates. The product can have a moisture content of from about 50% to about 99%. The product can further include alginate in an amount of from about 0.1% to about 10% by weight, on a dry matter basis. The product can have a pH of from about 3 to about 4.6. In particular embodiments, the product can have a pH of from about 3.5 to about 4.2.

In certain embodiments, the wet food product can include a solid portion having a gel hardness ranging from about 100 g to about 50,000 g and a liquid portion having a viscosity of from about 2 centipoise to about 2,000 centipoise.

In certain embodiments, the product can have a protein content of from about 5% to about 65% by weight, on a dry matter basis.

In certain embodiments, the product can be a jellified wet pet food.

The present disclosure further provides methods of feeding a pet animal including feeding a pet with a microbiologically stable jellified wet food product obtained by the methods disclosed herein or with a microbiologically stable jellified wet food product also disclosed herein.

### 4. BRIEF DESCRIPTION OF THE DRAWINGS

FIG. 1 depicts a graph illustrating ability to grip (i.e., prehension) of various wet food products. Abscissa, types of wet food products, on the x-axis from left to right: (i) “Formula without Pal Enhancer” refers to a wet food product as prepared in Example 1; (ii) “5% Pal Enhancer A” refers to a wet food product as prepared in Example 1 comprising 5% w/w of the palatability enhancer A; (iii) “3% Pal Enhancer B” refers to a wet food product as prepared in Example 1 comprising 3% w/w of the palatability enhancer B; (iv) “2% Pal Enhancer C” refers to a wet food product as prepared in Example 1 comprising 2% w/w of the palatability enhancer C; and (v) “Puppy” refers to the commercial wet food product marketed. Ordinate, units expressed as percent (%) from the total number of data. In each bar, from the bottom to the top: (i) bottom dark portion: instantaneous gripping (<=2 seconds); (ii) light grey portion: late gripping (>=2 seconds); and (iii) top dark portion (present for “5% Pal Enhancer A”): no grip. Differences in the results between the wet food products were not significant (p-value >5%).

FIG. 2 depicts a graph illustrating the acceptability of various wet food products. Abscissa, types of wet food products, on the x-axis from left to right: (i) “Formula without Pal Enhancer” refers to a wet food product as prepared in Example 1; (ii) “5% Pal Enhancer A” refers to a wet food product as prepared in Example 1 comprising 5% w/w of the palatability enhancer A; (iii) “3% Pal Enhancer B” refers to a wet food product as prepared in Example 1 comprising 3% w/w of the palatability enhancer B; (iv) “2% Pal Enhancer C” refers to a wet food product as prepared in Example 1 comprising 2% w/w of the palatability enhancer C; and (v) “Puppy” refers to the commercial wet food product marketed. Ordinate: percentage of the tested animal number that have ingested 100% of the provided wet food. Differences in the results between the wet food products were not significant (p-value >5%).

FIG. 3 depicts a graph illustrating the percentage of acceptability of various wet food products at 95% or more. The acceptability included total consumption of the product and partial consumption of the product higher or equal to 95%. Abscissa, types of wet food product, on the x-axis from left to right: (i) “Formula without Pal Enhancer” refers to a wet food product as prepared in Example 1; (ii) “5% Pal Enhancer A” refers to a wet food product as prepared in Example 1 comprising 5% w/w of the palatability enhancer A; (iii) “3% Pal Enhancer B” refers to a wet food product as prepared in Example 1 comprising 3% w/w of the palatability enhancer B; (iv) “2% Pal Enhancer C” refers to a wet food product as prepared in Example 1 comprising 2% w/w of the palatability enhancer C; and (v) “Puppy” refers to the commercial wet food product marketed. Ordinate: percentage of the tested animal number that have ingested 95% or more of the provided wet food. Differences in the results between the wet food products were not significant (p-value >5%).

### 5. DETAILED DESCRIPTION

The presently disclosed subject matter relates to improved methods for preparing wet food products, in particular “pâté”, “loaf” or “chunk and gravy” wet food products, which can be jellified. Such methods do not include a heat sterilization step. Thus, according to the methods of the present disclosure, performing a heat sterilization step such as a retorting step as known in the art is avoided. The presently disclosed methods advantageously provide microbiologically stable and highly palatable wet food products without undesirable products generated by the Maillard reaction from heat sterilization.

For clarity and not by way of limitation, this detailed description is divided into the following sub-portions:

5.1. Definitions;

5.2. Wet food compositions;

5.3. Methods of making wet food compositions; and

5.4. Features of wet food compositions and methods of making the same.

### 5.1. Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used herein, the terms “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

The term “alginate” as used herein refers to a salt of alginic acid.

The term “alginic acid” as used herein refers to its usual meaning in the art. Alginic acid is a linear copolymer with homopolymeric blocks of (1-4)-linked beta-D mannuronate (M) and its C-5 epimer alpha-L guluronate (G) residues, respectively, that are covalently linked together in different sequences or blocks.

The term “animal protein” as used herein refers to proteins that originate from vertebrates, such as mammals, poultry and fish. Animal protein can originate, for example, from muscle meat, organs, tendons or bone. Proteins originating from milk or eggs are not considered animal proteins.

The term “antioxidant” as used herein refers to a substance or a component that is capable of reacting with free radicals and neutralizing them.

The term “carbohydrate” as used herein encompasses polysaccharides and sugars that are metabolized for energy when hydrolyzed in the body.

As used herein, the term “chunk” alone includes a unitary piece consisting of at least one protein source mixed with binder ingredients, such as starch or alginate, that can be included as a component of animal feeds, such as dog and cat feeds.

As used herein, the term “chunk and sauce” refers to, for example, “chunk and gravy”, “chunk and jelly”, or “chunk and mousse” products.

The expressions “dry matter (DM) basis” must be interpreted as a method of expressing the concentration of a nutrient or a component in a feed by expressing its concentration relative to its dry matter content (the concentration remaining once the moisture has been taken out). At the opposite, the expression “as fed” must be interpreted as a method of expressing the concentration of a nutrient or a component in a feed by expressing its concentration in the state it is fed, which includes moisture.

The term “fat” as used herein refers to lipidic compounds, fatty acids and esters of fatty acids such as triglycerides, diglycerides, monoglycerides as well as phospholipids. The terms “fat”, or “source of fat” as used in the present specification comprises any food-acceptable fat (s) and/or oil (s) irrespective of their consistency at room temperature, i.e., irrespective whether said “source of fat” is present in essentially fluid form or in essentially solid from.

The terms “fibers” is similar to “dietary fibers” as used herein refers to Total Fibers, meaning that it includes soluble fibers and insoluble fibers.

The term “food” as used herein refers to a food composition designed for ingestion by a mammal, which includes human and non-human mammals. Non-human mammals encompass feline animals and canine animals, including pets such as feline pets and canine pets like cats and dogs.

The term “mammal” as used herein encompasses human and non-human mammals.

The term “microbiologically stable” as used herein refers to the status of a substance or product wherein outgrowth of bacterial cells, including of cells from pathogenic bacteria, is prevented.

The term “microbiological stability” as used herein refers to the property of a substance or product to prevent the outgrowth of bacterial cells, including preventing the outgrowth of cells from pathogenic bacteria such as of the genus Salmonella, Listeria, and Clostridium.

The term “non-animal protein” as used herein refers to proteins that are not animal protein. Examples of non-animal protein include vegetable proteins, algal proteins, egg proteins, milk proteins, microbial proteins and insect proteins.

The term “non-human mammal” as used according to its conventional meaning herein, encompasses feline animals and canine animals as well as mammal pets, which include cats and dogs.

The term “palatability” means a relative preference of an animal for one food product to another. Palatability refers to the overall willingness of an animal to eat a certain food product, Advantageously but not necessarily, palatability further refers to the capacity of the eaten food product to satisfy the animal. Whenever an animal shows a preference, for example, for one of two or more food products, the preferred food product is more “palatable”, and has “enhanced palatability”. The relative palatability of one food product compared to one or more other food products can be determined, for example, in side-by-side, free-choice comparisons, e.g., by relative consumption of the food products, or other appropriate measures of preference indicative of palatability. It can advantageously be determined by a standard testing protocol in which the animal has equal access to both food products such as a test called “two-bowl test” or “versus test” (see below). Such preference can arise from any of the animal's senses, but typically is related to, inter alia, taste, aftertaste, smell, mouth feel and/or texture.

The term “palatability enhancer” as used herein refers to any compound, composition, formulation, or other material useful for enhancing the attractiveness and palatability of a comestible composition such as a food composition, supplement, medicament, or the like. Thus, such palatability enhancer can contribute to initial appeal, continued consumption, or repeated presentation aspects of palatability, or any combination thereof. Such product can consist of liquid and/or powder palatants. Examples fats and oils (e.g. poultry fat, tallow), flavors, chemical molecules (e.g. 2,5 dimethylpyrazine), aromas, extracts (e.g. yeast), digests, hydrolysates (e.g. poultry liver), protein ingredient (e.g., poultry meal), carbohydrate food (e.g. rice flour), powders and the like. For example, the palatability enhancer can consist of fragrances such as food fragrances, odour masking agents and mixtures thereof, such as flavour compound as well as precursors for the above. The palatability enhancer does not consist of a food product or of a nutritional product.

The term “pet” as used herein refers to a domestic animal, including companion animals such as domestic cats and dogs.

The terms “pet food” “pet food product” as used herein refer to a food composition designed for ingestion by a pet. A jellified wet pet food product described herein typically is a nutritionally balanced food product to provide a pet with all the essential nutrients it needs in the right quantities.

The terms of “retort” or “retorting” as used herein refer to some step of heat sterilization that is performed in conventional methods of preparing wet food products. A retorting step is conventionally performed by heat sterilizing of a wet food product after it has been placed in its selected packaging (e.g., a pouch, a can, etc.).

The term “sauce” or “gravy” as used herein refers to an aqueous composition in the form of a viscous fluid, a paste, a gel or a mousse.

The term “starch” as used herein refers to a polysaccharide that is composed of amylose and amylopectin.

As used herein, the expression “selected in a group comprising” encompasses “selected in the group consisting of”.

The term “syneresis” as used herein refers to the expulsion of an aqueous liquid initially contained in a jellified material disclosed in the present description.

The term “wet food” as used herein refers to a food having a moisture content of 90% or less and of 50% or more.

The terms “wet food product” or “jellified wet food product” can be interchangeably used herein and mean a wet food product obtained by the method according to the present disclosure. These terms encompass both (i) a jellified wet food product under the form of a “pâté” or “loaf” or alternatively of a “chunk” and (ii) a jellified wet food product under the form of a “chunk and gravy” (that can also be termed “chunk and sauce”).

### 5.2. Wet Food Compositions

In certain embodiments, a wet food composition is provided. The wet food composition can be a jellified wet food product. In certain embodiments, the jellified wet food product can be complete or complementary such as treats. As provided in the Examples, a jellified wet food product obtained by methods according to the present disclosure can be microbiologically stable.

The wet food composition can include protein, fat, carbohydrates and optionally one or further food ingredients. In certain embodiments, the wet food composition can have a protein content of at most about 65% by weight, on a dry matter basis. In certain embodiments, the wet food composition can have a protein content ranging from about 5% to about 65% by weight, on a dry matter basis. In certain embodiments, the wet food composition can have a carbohydrate or starch content of at most about 50% by weight, on a dry matter basis. In certain embodiments, the wet food composition can have a carbohydrate or starch content in a range of from about 1.5% to about 2.5% by weight, on dry matter basis.

In certain embodiments, the wet pet food composition can include one or more organic acids, for example, lactic acid, citric acid, etc. In certain embodiments, the wet food composition can include fibers, for example, cellulose. In certain embodiments, the wet food composition can include vitamins, minerals, and combinations thereof, for example, vitamin and mineral premix. In certain embodiments, the wet food composition can include an aqueous liquid, for example, water. In certain embodiments, the wet food composition can include alginate in an amount ranging from about 0.1% to about 10% or from about 0.5% to about 0.8% by weight, on a dry matter basis. In certain embodiments, the wet food composition can include one or more palatability enhancers in an amount ranging from about 2% to about 5% by weight, on a dry matter basis.

In particular embodiments, the wet food composition can include water, oils and fats, palatability enhancers, poultry meal, cellulose, potassium chloride, potassium triphosphate (STPP), potassium sorbate, vitamin and mineral premix, alginate, lactic acid, citric acid, and starch.

In certain embodiments, the wet food composition can have a moisture content ranging from about 50% to about 99%. The moisture content of any jellified composition or product disclosed herein can be determined according to standard methods. For example, the moisture content can be determined by (i) weighing the composition or product; (ii) evaporating the free water contained therein, such as in an oven at a temperature ranging from about 100° C. to about 120° C. when performed at the atmospheric pressure, e.g., during a period of time ranging from about 1 hour to about 3 hours; and (iii) weighing the resulting dried composition or product, the weight difference consisting of the weight of water initially contained in the composition or product.

In certain embodiments, the wet food composition can include one or more portions. For example, the wet food composition can include a first portion and a second portion. The first portion can be a solid portion. In certain embodiments, the first portion can have a gel hardness of from about 100 g to about 50,000 g. The second portion can be a liquid portion. In certain embodiments, the second portion can have a viscosity ranging from about 2 centipoises to about 2,000 centipoises. The hardness of any jellified composition or product disclosed herein can be measured, for example, with an Ottawa Cell compressing device of a Brookfield® CT3 texture analyzer. The following operating parameters have been applied: trigger: 10 g, distance: 50 mm; and speed: 1 mm per second. The viscosity in centipoises of any composition or product disclosed herein can be determined, for example, by using a Brookfield® viscosimeter RV-DV, equipped with a RV spindle n° 2, at a 20 rpm speed.

In certain embodiments, the wet food composition can have a pH of from about 3.0 to about 4.6. In particular embodiments, the wet food composition can have a pH of from about 3.5 to about 4.2. The pH value of a jellified wet food composition disclosed herein can be measured according to any standard method, for example, by using a conventional pH meter equipped with a probe comprising a pH sensor.

In certain embodiments, the wet food composition can be a human food product. In certain embodiments, the wet food composition can be a pet food product, for example, a cat food product or a dog food product.

### 5.3. Methods of Making Wet Food Compositions

In certain embodiments, a method of manufacturing food compositions, such as jellified wet food products, is provided. The method can include preparing a pre-gel mixture comprising a combination of food ingredients, one or more alginate, and an aqueous liquid (i.e., step a). In certain embodiments, one or more organic acids can be added to the pre-gel mixture to provide a jellified composition (i.e., step b). The jellified composition can be subjected to a step of expulsing the aqueous liquid comprised therein (i.e., step c). Such steps can provide a jellified wet food product. In certain embodiments, the jellified wet food product obtained at step c) can be used as an edible food product. In certain embodiments, the jellified food product can also be termed a “pâté” or a “loaf”, for example, when applied to a wet pet food product.

In certain embodiments, the jellified wet food product obtained at step c) can be a portion of a final edible food product, such as a “chunk” of a final food product including a wet food product, e.g., “chunk in gravy” or “chunk in sauce”. According to certain embodiments, the final edible food product can be obtained by combining a chunk obtained at step c) of the method with a “gravy”. In certain embodiments, the gravy can be prepared according to a variety of known methods. Such a gravy can include, for example, one or more thickening agents for controlling its consistency, such as carrageenan, xanthan, guar gum, cassia gum, gelatin, and combinations thereof.

In certain embodiments, the method can further include collecting the aqueous liquid expulsed at step c) (i.e., step d). One or more thickening agents can be added to the aqueous liquid collected at step d) (i.e., step e) to provide an aqueous material of an increased viscosity. The method can further include adding the aqueous material obtained at step e) to the jellified composition obtained at the end of step c) to provide a jellified wet food product (i.e., step f).

In certain embodiments, at step f), a “two-parts” product or multi-portion product can be obtained. For example, the first part or portion can include a gel (e.g., the “chunk”) and the second part or portion can include a viscous liquid (e.g., the “gravy”). In certain aspects, combining the multiple portions can form a jellified wet food product in accordance with the present disclosure.

In certain embodiments, the method can further include an additional step which can be performed after step b) and before step c) of cutting the jellified composition obtained at step b) into pieces of a desired size.

In certain embodiments in which the jellified wet food product obtained at the end of step f) is to be provided to a non-human mammal, for example, to a pet such as a feline, a canine, a cat, or a dog, the jellified food can be a “chunk in a sauce” or a “chunk and gravy” wet food product.

### 5.3.1. Method Step a)

The various advantageous features of the jellified wet food product according to the present disclosure can be substantially imparted by the characteristics of the method for its manufacture. Such processes can encompass both (i) the characteristics of each method step; and (ii) the order in which the method steps are performed. Notably, important advantageous features of the jellified wet food product can be provided by the characteristics and order of steps a) and b) of the disclosed method. However, as person skilled in the art will appreciate that the present disclosure is not limited to the order in which the method steps are provided herein.

A variety of jellified wet food products can be obtained by performing the method according to the present disclosure. A person skilled in the art, on the basis on his general knowledge of the nutritional requirements for a targeted human or non-human mammal, which includes cats or dogs, will appreciate which combination of food ingredients, which amounts of these respective food ingredients, and optionally which combination and respective amounts of thermo-sensitive or thermolabile substances, have to be provided at step a) of the disclosed method.

At step a) of the present method, the starting material can include a combination of (i) a combination of food ingredients, which will be included in the final jellified wet food product; (ii) an appropriate volume of a liquid; and (iii) one or more alginates.

In certain embodiments, step a) can be performed by preparing a pre-gel mixture. The pre-gel mixture can be formed by, for example, a1) preparing a dry premix composition comprising a combination of food ingredients, one or more alginate, and a liquid; and a2) mixing the dry premix obtained at step a1) with a liquid. At step a), or alternatively a1), of the method, any alginate compound known in the art can be used. In certain aspects, the alginate is suitable for use in the food industry.

### i. Combination of Food Ingredients

In certain embodiments, the starting material can include one or more of protein, lipids or fats, carbohydrates, fibers, vitamins, minerals, EPA/DHA, palatability enhancers, further food ingredients of interest, or antioxidants. In particular embodiments, the combination of food ingredients present in the starting material can include the appropriate amounts of protein, lipids or fats, and carbohydrates. In certain embodiments, the starting material can further include fibers. Such ingredients can provide a final jellified wet food product with the desired nutritional properties.

In certain embodiments, the combination of food ingredients can be present in the starting material in amounts known in the art for ensuring a complete feeding of the final consumer, selected from a human or a non-human mammal, such as a cat or a dog. According to certain embodiments, the amounts of the respective food ingredients can be such that the resulting jellified food product can be termed a “nutritionally complete” food, e.g., for a healthy human or non-human mammal, such as a healthy cat or a healthy dog.

In certain embodiments, the respective amounts of protein, lipid, carbohydrate, and optionally fibers, can be present in the starting material so as to be suitable for feeding subjects, such as cats and dogs, undergoing one or more physiological dysfunctions, such as illustratively renal dysfunction.

For example, in certain embodiments, the starting material can include protein in an amount ranging from about 5% to about 65% by weight, on a dry matter basis, i.e., based on the total weight of dry matter of the starting material. The starting material used at step a) of the method can include a plurality of proteins that can be contained in a protein source which is used in the manufacture process. In certain embodiments, a protein comprised in a food composition can be in a native form. In certain embodiments, a protein can be present in an at least partially hydrolysed form, which encompasses a protein which is almost completely hydrolyzed. A food composition according to the present disclosure can incorporate proteins under the form of meat or animal derived material (e.g., beef, chicken, turkey, lamb, fish, blood plasma, marrow bone, etc. or one or more thereof). In certain embodiments, a food composition as described herein can be meat-free and can include a meat substitute protein source such as soya, maize, gluten, or any other protein-containing soya product in order to provide a protein source, and combinations thereof. A food composition as disclosed herein can include additional protein sources such as soya protein concentrate, milk proteins, gluten, etc.

As methods disclosed herein do not include any step of treatment at a high temperature and do not include any heat sterilization step and thus no retorting step, performing the disclosed method with a starting material comprising proteins under the form of protein hydrolysate advantageously does not cause heat alteration, including coagulation, of such a thermo-sensitive ingredient.

In certain embodiments, the starting material can include one or more carbohydrates in an amount ranging from about 0.1% to about 40% by weight, on a dry matter basis, i.e., based on the total weight of dry matter of the starting material. The carbohydrate content of foods can be determined by any number of methods known by those of skill in the art. However, in the present disclosure, and unless the contrary is clearly specified, the carbohydrate percentage is calculated as nitrogen free extract (“NFE”), which can be calculated as follows:

NFE=100%—moisture %—protein %—fat %—ash %—crude fiber %.

Carbohydrates can be supplied under the form of any of a variety of carbohydrate sources known by those skilled in the art, including oat fiber, cellulose, peanut hulls, beet pulp, parboiled rice, corn starch, corn gluten meal, and any combination thereof. Grains supplying carbohydrates include, but are not limited to, wheat, corn, barley, and rice.

In certain embodiments, the starting material can include fat in an amount ranging from about 0.5% to about 60% by weight, on a dry matter basis, i.e., based on the total weight of dry matter of the starting material. The composition according to the present disclosure can comprise fat of animal and/or vegetable origin. Fat can be supplied by any of a variety of sources known by those skilled in the art. Plant fat sources include, without limitation, wheat, sunflower, safflower, rapeseed, olive, borage, flaxseed, peanuts, blackcurrant seed, cottonseed, wheat, germ, corn germ, as well as oils derived from these and other plant fat sources. Animal sources include, for example and without limitation, chicken fat, turkey fat, beef fat, duck fat, pork fat, lamb fat, etc., fish oil or any meat, meat by-products, seafood, dairy, eggs, etc. Fat content of foods can be determined by any number of methods known by those of skill in the art.

In certain embodiments, the starting material can comprise fibers in an amount ranging from about 0.5% to about 40% by weight, on a dry matter basis, i.e., based on the total weight of dry matter of the said starting material. The composition according to the present disclosure can include fibers which can be similar to dietary fibers and include soluble and insoluble fibers. Soluble fiber (also referred to as fermentable fibers) can be defined as being resistant to digestion and absorption in the small intestine and undergo complete or partial fermentation in the large intestine. As non-limitative example of soluble fibers can include beet pulp, guar gum, chicory root, psyllium, pectin, blueberry, cranberry, squash, apples, oats, beans, citrus, barley, or peas. In certain embodiments, the soluble fiber can be chicory pulp. Soluble fibers can be considered as having a prebiotic effect by providing short chain fatty acids as a source of energy to colonocytes. By opposition, insoluble fiber (also referred as non-fermentable fibers) can be defined as non-starch polysaccharides that are resistant to digestion and absorption in the small intestine, and resistant to fermentation in the large intestine. As non-limitative example of insoluble fibers, it can be mentioned cellulose, whole wheat products, wheat oat, corn bran, flax seed, grapes, celery, green beans, cauliflower, potato skins, fruit skins, vegetable skins, peanut hulls, and soy fiber. In certain embodiments, insoluble fiber can be cellulose. Insoluble fibers can be considered as useful for transit and ballast effect.

In certain embodiments, the combination of food ingredients used at step a) can include protein, fat, and carbohydrates, in which the protein content can be less than about 65% by weight of the combination of food ingredients, on a dry matter basis. In certain embodiments, the combination of food ingredients used at step a) can include protein, fat, and carbohydrates, in which the protein content is at least about 5% by weight of the combination of food ingredients, on a dry matter basis.

In certain embodiments, the combination of food ingredients used at step a) can include protein, fat, carbohydrates and optionally fibers, and further can include one or more ingredients that can be selected in a group comprising one or more minerals, one or more vitamins, and one or more palatability enhancers.

In certain embodiments, the starting material used at step a) can include one or more vitamins.

The one or more vitamins can include vitamin A, vitamin B1, vitamin B2, vitamin B6, vitamin B12, vitamin C, vitamin D, vitamin E, vitamin K, biotin, folic acid, inositol, niacin, pantothenic acid, and combinations thereof.

In certain embodiments, the starting material used at step a) can include one or more minerals. The one or more minerals can be comprised as constituents of sources of these minerals. For example, calcium can be comprised in the starting material as a constituent of food ingredients, for example, as a constituent of ground bone that is comprised in the combination of food ingredients present in the starting material. The one or more minerals can include calcium, phosphorus, sodium, chloride, potassium, magnesium, oligo elements, and combinations thereof. In particular embodiments, calcium, when present in the starting material at step a), is not under the form of free calcium cations but in contrast in a form bound to one or more constituents of the combination of food ingredients present in the starting material. Further illustratively, in certain embodiments, phosphorus can be present in the starting material under the form of phosphoric acid.

In certain embodiments, the starting material used at step a) can include EPA/DHA, for example, to improve metabolic status and generate an anti-inflammatory effect. In certain embodiments, the starting material used at step a) can include from about 0.4% to about 0.8% or about 0.6% by weight of EPA/DHA, on a dry matter basis, i.e., based on the total weight of dry matter of the starting material. In the present disclosure, the amount of EPA/DHA can contributes to the total amount of fat comprised in a composition or product disclosed herein.

In certain embodiments, one or more palatability enhancers can be present in the starting material. A person skilled in the art would appreciate a wide variety of palatability enhancers known and are suitable for use with the present disclosure. In certain embodiments, the one or more palatability enhancers can include butyric acid, 3-methylbutyric acid, tetrasodium pyrophosphate, 2-piperidione, 2,3-pentanedione, 2-ethyl-3,5-dimethylpyrazine, furfural, sulfurol, indole, and combinations thereof.

In certain embodiments, the combination of food ingredients of the starting material can include one or more other molecules or substances of nutritional interest. In certain embodiments, the one or more further food ingredients of interest can include vitamins, probiotics, prebiotics, aromas, antioxidants, yeasts, bacteria (e.g., bacterial dormant cells), amino-acids, and combinations thereof.

Nutrients as further food ingredients, as non-limitative examples, can include taurine, green lipped mussel, chondroitin, collagen, polyphenols, flavonoids, curcuminoids, aloe vera extract, and combinations thereof.

In certain embodiments, the starting material used at step a) can include a source of antioxidants. In certain aspects, numerous antioxidants are known to be affected by heat treatment, especially by heat sterilization treatment. Examples of such substances include, without limitation, carotenoids, including beta-carotene, lycopene and lutein, selenium, coenzyme Q10 (ubiquinone), tocotrienols, soy isoflavones, S-adenosylmethionine, glutathione, taurine, N-acetylcysteine, lipoic acid, and L-carnitine.

The amount of food ingredients other than protein, fat, carbohydrate and optionally fibers, in embodiments where one or more of these further ingredients are present, can vary according to the desired qualitative and quantitative constitution in ingredients which is sought in the final jellified wet food product, provided that the total quantity of ingredients amounts to 100% of the said combination of food ingredients used at step a).

### ii. Aqueous Liquid

In certain embodiments, the starting material can include an aqueous liquid. The liquid used in the starting material used at step a) of the method can encompass a variety of aqueous liquids that are suitable for use in the nutritional technical field. Thus, a person skilled in the art will appreciate a wide variety of aqueous liquids are suitable for use with the present disclosure.

In certain embodiments, the aqueous liquid which is used at step a) of the method can include water, milk, vegetable juice, fruit juice, or any plants-based juice. In certain embodiments, the aqueous liquid can include a certain amount of an oily substance, such as an animal oil or a vegetable oil. In certain embodiments, the aqueous liquid which is used at step a) of the method can include water.

In certain embodiments, the aqueous liquid is present in the starting material in an amount of from about 30% to about 99% by weight, based on the total weight of the starting material.

### iii. Alginate

In certain embodiments, the starting material can include alginate. Alginate can be used including in the pet food industry, for example, as a gelling agent. Alginates used at step a) can include salts of alginic acid with mono-cationic molecules (i.e., monocations). As such, salts of alginic acid with multi-cationic molecules, such as for example calcium alginate, can be used alternatively at step a) of the method disclosed herein. A salt of alginic acid and a monocation can also be termed “monocation alginate” herein.

In certain embodiments, step a) of the method can include preparing a pre-gel mixture comprising a combination of food ingredients, one or more alginate, for example, a monocation alginate, and a liquid. At step a) of the method, the one or more alginate can include sodium alginate, potassium alginate, ammonium alginate, and combinations thereof.

In certain embodiments, the alginate(s) can be collectively present in the starting material in an amount ranging from about 0.1% w/w to about 10% w/w, based on the total weight of the starting material. The amount of alginate(s) present in the starting material at step a) can be of about 0.1% w/w or more, about 0.2% w/w or more, about 0.3% w/w or more, or about 0.4% w/w or more. The amount of alginate(s) present in the starting material at step a) can be of about 10% w/w or less, about 9% w/w or less, about 8% w/w or less, about 7% w/w or less, about 6% w/w or less, about 5% w/w or less, about 4% w/w or less, about 3% w/w or less, or about 2% w/w or less. In certain embodiments, the amount of alginate(s) present in the starting material at step a) ranges from about 0.4% w/w to about 2% w/w, based on the total weight of the starting material.

The “starting material” of step a) can include of the combination of (i) the combination of food ingredients; (ii) the one or more alginate, such as the one or more salts of an alginic acid with a monocation; and (iii) the liquid that are used at step a) for preparing a pre-gel mixture.

As person skilled in the art will appreciate that various alginates are available and are suitable for use with the present disclosure. In certain embodiments, alginate can be derived from brown seaweeds, such as the giant kelp, Microcystis pyrifera. Alginate can also be derived from a variety of Laminaria, such as Laminaria digitate, Laminaria saccharina or Laminaria hyperborean. In certain embodiments, alginate can be derived from Eisenia bicyclis, or Ascophylum nodosum.

Alginate polymers include a combination of sugars M ((1-4)-linked beta-D mannuronate) and G (C-5 epimer alpha-L guluronate). One skilled in the art can select an alginate having an appropriate M/G ratio, for example, depending (i) on the amount of alginate to be comprised in the starting material; and (ii) on the level of hardness that is desired for the resulting jellified wet food that is obtained at the end of the method. “High G” alginates such as from L. hyperborea can form relatively hard, brittle gel, whereas “low G” alginates such as from A. nodosum can form relatively softer, more elastic gels.

Illustratively, alginates derived from the blade of L. Hyperborea can have an M/G ratio of 0.45/0.55. Alginates derived from the cortex of L. Hyperborea can have an M/G ratio of 0.25/0.75. Alginates derived from L. digita can have an M/G ratio of 0.59/0.41. Alginates derived from the reproduction organs of Ascophylum nodosum can have an M/G ratio of 0.90/0.10.

One skilled in the art will appreciate an appropriate alginate can be selected, for example, depending on the physical properties that are sought for the jellified wet food to be obtained at the end of the method according to the present disclosure. In certain embodiments, the alginate which is used at step a) of the method can include sodium alginate.

### Further Embodiments of Step a)

In certain embodiments of step a), the starting material can be further added with at least one divalent cation, for example, calcium ions in the form of calcium salt. The calcium salt can include calcium phosphates, calcium sulfate, calcium carbonate, calcium chloride, or calcium lactate.

According to certain embodiments, calcium can be added in a quantity so as to be present in the pre-gel mixture at an amount ranging from about 0.1% to about 10% by weight, based on the total weight of the pre-gel mixture.

In certain aspects, the presence of calcium salt in the starting material used at step a) of the disclosed method does not provide calcium as free cations in the resulting pre-gel mixture.

In certain embodiments, one or more sequestrant agents can be added to the starting material of step a). The one or more sequestrant agents can bind free calcium, if free calcium is present in the resulting pre-gel mixture, and thus prevent pre-gelation of the alginate during step a).

According certain embodiments, the one or more sequestrant agents can include pyrophosphates, orthophosphates, polyphosphates, citrates, and combinations thereof.

### Conditions of Step a)

In certain embodiments, food ingredients in the combination of food ingredients can be provided as fresh food ingredients, freezed food ingredients, or dehydrated food ingredients. In certain embodiments, the food ingredients can be in a powder form, such as in a dehydrated powder form.

In certain embodiments of step a), the combination of food ingredients can include a combination of dry food ingredients, which results in a dry mixture of food ingredients. A number of food ingredients under the form of powders are commercially available.

In certain embodiments, the whole food ingredients can be under a dry form, such as under a powder form.

In certain embodiments, one or more of the food ingredients in the combination of food ingredients can be in a liquid form. According certain embodiments, the one or more liquid food ingredients can be present in the liquid to which is added the dry mixture of food ingredients, at step a) of the method. Illustrative food ingredients that can be provided, without limitation, in a liquid form include vegetable or animal oils, palatability enhancers as well as liquid combinations (i.e., cocktails) of vitamins.

In certain embodiments, one or more of the food ingredients which are provided for preparing the dry mixture consisting of the combination of food ingredients can be sterile. In certain embodiments, each of the food ingredients provided can be sterile.

In embodiments of step a), including in embodiments of step a) which are further described as comprising steps a1) and a2), the combination of food ingredients can be added to the liquid and the resulting wet mixture can be stirred so as to form a homogenous pre-gel mixture. In certain embodiments, alginate can be provided at step a) under a dry form, such as in a powder form. In certain embodiments, the food ingredients and alginate can be in a dry form, such as in a powder form. In certain embodiments, the liquid and the other ingredients can be mixed until they form a homogenous mixture that results in a pre-gel mixture.

In certain embodiments, the duration of step a) does not substantially influence the features of the pre-gel mixture, provided that a homogenous pre-gel mixture is obtained. Step a) can be performed during a time period sufficient to obtain a homogenous pre-gel mixture. In certain embodiments, step a) can be performed during a time period ranging from about 1 to about 30 minutes, from about 1 to about 10 minutes, or from about 1 to about 5 minutes.

In certain embodiments, step a) can performed at ambient temperature, for example, at a temperature ranging from about 10° C. to about 40° C. or from about 10° C. to about 30° C.

In certain aspects, any stirring apparatus or mixer device known in the art can be used for performing step a) of the method.

### 5.3.2. Method Step b)

At step b) of the method, one or more organic acids can be added to the pre-gel mixture obtained at the end of step a). The addition of one or more organic acid to the pre-gel mixture can allows for gelation to occur so as to obtain a jellified composition at the end of step b).

The one or more organic acids used at step b) can include Formic acid, Sorbic acid, Acetic acid, Lactic acid, Propionic acid, DL-Malic acid, Fumaric acid, Citric acid, Ascorbic acid, Phenylacetic acid, Butyric acid, 2-Methyl-2-pentenoic acid, Dec-2-enoic acid, Citronellic acid, L-Aspartic acid, L-Glutamic acid, Cinniamic acid, 2-Methylpropionic acid, 2-Methylcrotonic acid, Propionic acid, Valeric acid, 3-Methylbutyric acid, Hexanoic acid, Octanoic acid, Decanoic acid, Dodecanoic acid, Oleic acid, Hexadecanoic acid, Tetradecanoic acid, Benzoic acid, 4-Oxovaleric acid, Succinic acid, Fumaric acid, Heptanoic acid, Nonanoic acid, 2-Methylvaleric acid, 2-Ethylbutyric acid, 2-Methylbutyric acid, 2-Methylheptanoic acid, 4-Methylnonanoic acid, 4-Methyloctanoic acid, Gallic acid, Tannic acid, Glucono-delta-lactone, and combinations thereof. In certain embodiments, the one or more organic acids can include Lactic acid, Citric acid, Gluconic acid, Ascorbic acid, and combinations thereof.

Without being bound to a particular theory, the one or more organic acids which are added at step b) can cause the release of free calcium cations from one or more of the food ingredients present in the pre-gel mixture, which free calcium cations then can combine with the alginate so as to cause alginate gelation.

In certain embodiments, one or more mineral acids, such as phosphoric acid, can further be added at step b), for example, to adjust the pH of the jellified composition at a predetermined value. In certain embodiments, the pH of the jellified composition which is obtained at the end of step b) can be from about 3.0 to about 4.6 or from about 3.5 to about 4.2.

The amount of organic acid that is added to the pre-gel mixture, at step b) of the method, can be readily determined by one skilled in the art, for example, since it includes the amount of organic acid that is required for obtaining a jellified composition having the desired strength, an optionally also the desired pH, at the end of step b), irrespective of the organic acid or of the combination of organic acids which is used.

In certain embodiments in which the organic acid includes citric acid, citric acid can be added to the pre-gel mixture to be present in the jellified composition at the end of step b) at an amount ranging from about 0.5% to about 2.5% by weight, based on the total weight of the jellified composition.

In certain embodiments in which the organic acid includes lactic acid, lactic acid can be added to the pre-gel mixture so as to be present in the jellified composition at the end of step b) at an amount ranging from about 0.25% to about 1.25% by weight, based on the total weight of the jellified composition.

As provided above, the pH of the resulting jellified composition can be adjusted by the further presence of an appropriate amount of one or more mineral acid, such as by the further presence of an appropriate amount of phosphoric acid. For example, citric acid and/or lactic acid can be added to the pre-gel mixture so as to be present in the jellified composition at the end of step b) at an amount respectively of about 1.33% and about 0.66% by weight, based on the total weight of the jellified composition. According to such an embodiment, the jellified composition obtained at the end of step b) can have a pH of about 4.1.

The jellified composition can be obtained at step b) by agitating the combination of pre-gel composition with acid(s), preferably at a relatively high speed, while the gel is forming. The gel can be initially formed rapidly, for example, in a time period of a few minutes.

In certain embodiments, step b) can include, following the time period of a rapid formation of a gel, a time period of gel resting, which can last from about 10 minutes to about 100 minutes or from about 20 minutes to about 60 minutes.

In certain embodiments, step b) can be performed at ambient temperature, for example, at a temperature ranging from about 10° C. to about 40° C. or from about 10° C. to about 30° C.

### Optional Cutting Step

In certain embodiments of the method, the jellified composition obtained at step b) of the method can be cut into smaller pieces prior to performing step c) of expulsing part of the liquid which is contained therein, and in particular by expulsing an amount of liquid of up to about 40% by weight, up to about 30% by weight, or up to about 25% by weight, based on the total weight of the jellified composition that is obtained at step b), such as an amount of liquid ranging from about 5% by weight to about 40% by weight, from about 5% by weight to about 30% by weight, or from about 10% by weight to about 25% by weight, based on the total weight of the jellified composition that is obtained at step b). Thus, in certain embodiments, the jellified composition obtained at step b) can be cut into pieces of a predetermined size according to methods known in the art, for example, by using a variable speed knife. This step can allow for obtaining a jellified composition in the form of fixed-length or variable length strips or blocks.

The optional cutting step can also be performed by conveying the jellified composition obtained at step b) to a multi-dimensional dicer where both length and width can be altered to provide irregularly-shaped pieces of jellified composition having dimensions suitable for the intended use of the final wet food product.

### 5.3.3. Method Step c)

Step c) of the method can be performed either (i) starting from the jellified composition obtained at step b) of the method or (ii) starting from the pieces of jellified composition obtained at the end of the above-described optional cutting step. Step c) of the method is described herein when using the jellified composition of step b). However, the described conditions of step b) identically apply when pieces of the jellified composition obtained at the end of the optional cutting step are used.

Step c) of the method can include expulsing an amount of the liquid that is contained in the jellified composition at an amount of up to about 40% by weight, up to about 30% by weight, or up to about 25% by weight, based on the total weight of the jellified composition that is obtained at the end of step b). In certain embodiments of step c), the amount of expulsed liquid can be from about 5% by weight to about 40% by weight, from about 5% by weight to about 30% by weight, or from about 10% by weight to about 25% by weight, based on the total weight of the jellified composition that is obtained at step b).

In certain embodiments, step c) can be performed by subjecting the jellified composition to the atmosphere pressure during a period of time sufficient for the desired amount of liquid to be expulsed from the jellified composition obtained at step b).

In certain embodiments, at least portion of the liquid contained in the jellified composition obtained at step b) can spontaneously exit the gel network through a mechanism termed “syneresis”. Spontaneous expulsion of the liquid contained in the gel network of the jellified composition obtained at step b) can result from the progressive crosslinking of the alginate chains during the gel formation beyond the gel point as well as from the structural rearrangements which are associated thereto. Expulsion of the liquid contained in the jellified composition obtained at step b) can lead to a compaction of the jellified composition.

In certain embodiments, step c) can be performed by subjecting the jellified composition to a pressure that is higher than the atmosphere pressure, so as to shorten the duration of step c) and have the liquid contained in the jellified composition expulsed more rapidly. In certain embodiments in which the jellified composition is subjected to a pressure higher than the atmospheric pressure, it can be used any press device that is known from the one skilled in the art.

The jellified material obtained at the end of step c) can include a jellified wet food product according to the present disclosure. In certain embodiments, the jellified wet food product can include a food which is “ready to use”, i.e., which is readily in its final form that is intended for ingestion by the subject, particularly in its final form edible by a non-human mammal such as a feline or a canine, such as a cat or a dog. In certain embodiments, the jellified wet food product obtained at step c) can be one part of a “two-parts” food product, particularly of a “chunk in gravy” “two-parts” food product.

As noted above, depending on the qualitative constitution in the food ingredients provided at step a), the jellified wet food product obtained at the end of step c) can be (i) a “pâté” or a “loaf” or alternatively of (ii) a “chunk”, according to the conventional general meanings given to these terms in the art, irrespective of the known process for their preparation.

“Loafs” or “pâtés” can designate wet foods, especially wet pet foods, in the form of a single piece of reconstituted animal material packaged in a container, such as a can, a pouch or a tray. These shaped pieces of reconstituted animal material can have a piece volume of from about 20 to about 2,000 cm³, from about 40 to about 1,500 cm³, or from about 500 to about 1,200 cm³.

According to the present disclosure, a “loaf” or “pâté” can be prepared by processing a mixture of edible components according to steps a) to c) of the disclosed method to produce a homogeneous semi-solid mass that is structured by gelification. This homogeneous mass can be then packaged into single serve or multi-serve packaging which can then be sealed without requiring any step of heat sterilization, i.e., without requiring any retorting step. Upon packing, the homogeneous mass can assume the shape of the container.

Through the chunk-making method disclosed herein, the meat source and binder can be transformed into a “meat like chunk” that can closely resemble a chunk of actual meat. A “meat like chunk” can be understood as a product, produced from a protein source and a binder, variations in color, and/or variations in one or more linear dimensions between individual meat like chunks that provide many of the visual and/or textural features associated with natural meat.

In certain embodiments, a “chunk” wet food product obtained at step c) of the disclosed method can have a hardness ranging from about 100 to about 50,000 grams, for example, as measured with a compression analyzer device. As known in the art, the hardness of the jellified wet food product can correspond to the maximum force used to break the gel. The value of the gel hardness is used as a reference for characterizing the texture of the jellified product.

In certain embodiments in which the jellified material obtained at step c) is a chunk, the chunk can be further combined with a “gravy” or “sauce” so as to obtain a final wet food product under the form of a “chunk and gravy”, which can also be termed “chunk and sauce”.

The “gravy” portion can have a fluid characteristic and can supply aroma, palatability, and some additional nutritional properties to the food product such as additional vitamins, minerals, and the like. The “gravy” can include a liquid carrier, such as water, fats or oils and one or more thickening agents. The “gravy” component can be any suitable sauce conventional in the art of wet food, particularly in the art of wet pet food, and can exhibit a water content of at least about 80 wt %, at least about 90 wt %, or no more than about 98 wt %, by total weight of the sauce. The “gravy” can include one or more thickening agents which can be used to control its consistency. Thickeners or gelling agents that can be used to prepare the sauce include carrageenan, xanthan, guar gum, locust bear gum, cassia gum, starch, and combinations thereof. The sauce can be a coating which surrounds the reconstituted animal material, i.e., the “chunk”.

Starting from the jellified wet food product obtained at step c) of the disclosed method, particularly in the embodiments wherein the jellified wet food product comprises a “chunk”, the further steps of the disclosed method can allow for obtaining a final jellified wet food product of the kind “chunk and gravy”, as provided in detail below.

In certain embodiments, step c) can be performed at ambient temperature, for example, at a temperature ranging from about 10° C. to about 40° C. or from about 10° C. to about 30° C.

### 5.3.4. Method Step d)

At step d) of the method, the liquid that has been expulsed from the jellified composition at step c) can be collected. As will be readily understood, steps c) and d) can be performed simultaneously or almost simultaneously, since the liquid that is expulsed at step c) from the jellified composition previously obtained at step b) can be immediately collected at step d).

In certain embodiments, step d) can be performed at ambient temperature, for example, at a temperature ranging from about 10° C. to about 40° C. or from about 10° C. to about 30° C.

### 5.3.5. Method Step e)

At step e) of the method, the viscosity of the liquid previously collected at step d) can be increased, for example, to provide a viscous liquid having the general consistence of a “gravy”. At step e), one or more thickening agents can be added to the liquid collected at step d), for example, to provide a liquid material of an increased viscosity. In certain embodiments, the combined collected liquid and one or more thickening agents can be mixed and the resulting mixture can then be stirred until a homogenous liquid of the desired viscosity is obtained.

In certain embodiments, the one or more thickening agents can include xanthan gum, guar gum, iota-carrageenan, kappa-carrageenan, locust bean gum, native starches, pregelatinized starches, chemically modified starches, and combinations thereof.

In certain embodiments, the viscosity of the liquid material at the end of step e) can range from about 5 centipoises to about 2,000 centipoises. In certain embodiments, the measurements can be performed at room temperature (20° C.) by using a Brookfield® viscosimeter RV-DV, equipped with a RV spindle n° 2, at a 20 rpm speed.

Selecting the appropriate amount(s) of the one or more thickening agent(s) so as to obtain a resulting liquid material of a desired increased viscosity is in the general knowledge of the skilled artisan. For example, a desired increased viscosity of the liquid collected at step d) can be obtained by adding at step e) starch as a thickening agent such that starch is present in the resulting viscous liquid (i.e., “gravy”) at an amount of at most about 20% by weight, based on the total weight of the said viscous liquid to which it is added. For example, in certain embodiments, starch can be present at an amount ranging from about 0.1% to about 10% by weight, based of the total weight of the final viscous liquid which is obtained at the end of step e), depending of the kind of starch or combination of starches which is used, of the volume of liquid to be rendered more viscous, and of the desired viscosity of the said final liquid. When starch is used as a thickening agent at step e) of the disclosed method, it can include native starches, pregelatinized starches, chemically modified starches, or combinations thereof.

The liquid of increased viscosity which can be obtained at the end of step e) can be termed “sauce” or also “gravy” as used herein.

In certain embodiments, step e) can be performed at ambient temperature, for example, at a temperature ranging from about 10° C. to about 40° C. or from about 10° C. to about 30° C.

### 5.3.6. Method Step f)

At step f), the viscous liquid (i.e., “sauce” or “gravy”) which is obtained at step e) can be combined with the jellified composition obtained at step c) so as to provide a wet food product. In certain embodiments, the whole volume of the “sauce” obtained at step e) can be combined with the jellified composition obtained at step c). In certain embodiments, water can be added and mixed with the whole volume of the “sauce” obtained at step e) and the resulting liquid mixture can be combined with the jellified composition obtained at step c).

In certain embodiments, only a part or portion of the volume of the “sauce” obtained at step e) is combined with the jellified composition obtained at step c). In particular embodiments, the combined “sauce” and jellified composition can be gently agitated, for example, in order to obtain an homogenous mixture between the solid and liquid parts thereof.

The final product obtained at the end of step f) is a wet food product according to the present disclosure. The wet food product obtained at step f) can be of the type “chunk and sauce” or “chunk in gravy”, as is known in the art.

In certain embodiments, a “chunk” wet food product which is obtained at step c) of the disclosed method can have hardness ranging from about 100 to about 50.000 grams. The measurements can be realized, for example, by using an Ottawa Cell compressing device of a Brookfield® CT3 texture analyzer with the following operating parameters: trigger: 10 g, distance: 50 mm, speed: 1 mm per second. The hardness of the jellified wet food product can correspond to the maximum force used to break the gel. The value of the gel hardness is used as a reference for characterizing the texture of the jellified product.

In the resulting jellified food product, the liquid of increased viscosity (i.e., the “sauce”) can have a viscosity ranging from about 2 to about 2,000 centipoises. The measurements can be realized at room temperature (20° C.), for example, by using a Brookfield® viscosimeter RV-DV, equipped with a RV spindle n° 2, at a 20 rpm speed.

In certain embodiments, the jellified wet food product can be a human food product.

In certain embodiments, the jellified wet food product can be a pet food product, and in particular a cat food product or a dog food product.

In certain embodiments, step f) can be performed at ambient temperature, for example, at a temperature ranging from about 10° C. to about 40° C. or from about 10° C. to about 30° C.

In certain embodiments, the jellified wet food product obtained at step f) of the method can then be placed into appropriate cans, which cans are then sealed so as allowing the suitable storage or the jellified wet food product until use. Otherwise said, in the embodiments wherein both the “chunk” and the “gravy” can be obtained by the disclosed method, step f) can performed in the said selected container.

The present disclosure also provides a method of feeding a pet animal comprising a step of feeding a pet with a microbiologically stable jellified wet food product obtained by the method according to the present disclosure or with a microbiologically stable jellified wet food as described herein.

### 5.4. Features of the Wet Food Compositions and Methods of Making the Same

In certain aspects, the final wet food product obtained by the methods according to the present disclosure, which has not undergone any step of heat sterilization, can be devoid of bacterial contamination. In certain embodiments, the wet food product can be devoid of contamination with pathogenic bacteria. Further, in certain embodiments, the wet food product obtained by the present methods can have antibacterial properties in the absence of any added antibacterial agent. As provided in the Examples herein can further prevent growth of exogenously provided bacteria, including preventing growth of exogenously provided pathogenic bacteria such as various strains of Salmonella, Listeria, and Clostridium.

Further, as provided in the Examples, wet food products prepared by methods according to the present disclosure can have a high palatability. It was advantageously found that the addition of one or more palatability enhancer agents is not compulsory for further increasing acceptability of the resulting wet food products.

Additionally, as methods according to the present disclosure do not include a heat sterilization step, the resulting wet food product does not include undesirable products generated by the Maillard reaction. As such, the wet food products obtained by the disclosed method provide a reduced health risk of the human or non-human consumer along with increased palatability.

As the method according to the present disclosure does not include any step of heat sterilization, notably does not comprise any retorting step, thermolabile or thermo-sensitive agents, such as proteins, protein hydrolysates, amino acids, vitamins, probiotics (e.g., dormant spores), aroma substances, antioxidant agents, are not altered or destroyed. These highly advantageous properties of the disclosed method allow avoiding adding thermolabile or thermo-sensitive substances in excess in the starting mixture comprising a combination of food ingredients, so as to compensate for the loss of these ingredients during excess heating. These properties of the disclosed method also allow a good control of the desired content in thermolabile or thermo-sensitive agents in the resulting final wet food product, since their content variability, that would have otherwise been caused by their uncontrolled alteration by heat if obtained according to conventional methods, is avoided.

According to further aspects, the absence of a heat sterilization step, notably the absence of any retorting step, also allows a tight control of the hardness of the final jellified wet food product, notably because of the absence of any cross-linking reaction occurring between. Constitutive molecules of starch, if present, or protein molecules, which cross-linking reactions would otherwise necessarily occur during manufacturing processes involving one or more steps at a high temperature, such as a heat sterilization step, and can bring changes in the texture of the final product.

As provided herein, the method disclosed allows to obtain two main kinds of jellified wet food products, namely (i) jellified wet food products of the kind “pâté” or “loaf” as well as “chunk” and (ii) jellified wet food products of the kind “chunk and gravy”. In particular, the disclosed method allows providing a jellified wet food product (e.g., a “pâté” or “loaf” or in some embodiments a “chunk”) through a method allowing the simultaneous production of a liquid that can be further texturized so as to obtain a “sauce” optionally aimed at being used as the “gravy” of a jellified wet food product belonging to the kind “chunk and gravy”.

Still further, a wet food product obtained by the method disclosed herein is well structured as it is in the form of a gel (“pâté” or “loaf” or alternatively “chunk”), or in some embodiments a gel in a viscous liquid (i.e., “chunk and gravy” type). As such, the jellified wet food product can be cohesive with a reduced propensity to disintegrate, which structure properties impart both a good suitability for its packaging in containers, like conventional cans, and also a high acceptability for the human and non-human consumers. Further, since the jellified wet food product prepared by the method according to the present disclosure is obtained by a method that does not comprise a step of heat sterilization whereas being microbiologically stable, it can be packaged according to packaging methods that are not conventional in this technical field, notably according to packaging methods that do not require sterile containers, or alternatively that do not require heat sterilization of the containers previously filled with the said wet food product. Such kind of suitable containers, for a jellified wet food product according to the present disclosure, encompass aluminum containers, such as aluminum trays and carton containers for alimentary use, such as waxed cartons. The packaged jellified wet food product can be proposed in any existing human or pet food container for ready to use (as a re-closable tray), fresh products food (as yogurts), long shelf life containers (as pouches, cans, trays, Tetra Pak®) and also a high acceptability for the human and non-human consumers.

As provided herein, the method according to the present disclosure does not include any heat sterilization step leading to the generation of undesirable compounds resulting from the occurrence of Maillard reactions. Importantly, the disclosed method allows preparing a final microbiologically stable edible jellified wet food product, i.e., a “ready to use” microbiologically stable jellified wet food product, without performing any retorting step, in contrast to the methods known in the art.

Each of the whole steps of the disclosed method, i.e., each of the whole step a) to c), as well each of the further steps d) to f), can be performed at a temperature of at most about 40° C. In certain embodiments, each of the steps of the disclosed method can be performed at a temperature ranging from about 10° C. to about 40° C.

### 6. EXAMPLES

The presently disclosed subject matter will be better understood by reference to the following Examples, which are provided as exemplary of the disclosure, and not by way of limitation. The following Examples are merely illustrative of the presently disclosed subject matter and they should not be considered as limiting the scope of the subject matter in any way.

### Example 1: Methods of Preparing Wet Foods

The present Example provides methods for preparing wet foods (about 1 kg) in accordance with the present disclosure. The process included Steps 1 to 12 for preparing a “chunk and gravy” wet food composition. A “pâté” or “loaf” wet food composition was further prepared by performing Steps 1 to 8.

Step 1. A matrix of raw materials including 107.3 g of poultry meal, 18.4 g of cellulose, 1.2 g of potassium chloride, 0.8 g of sodium triphosphate (STPP), 3 g of potassium sorbate, and 4 g of mineral and vitamin premix was blended with 8 g of sodium alginate to form a dry mix.

Step 2. The dry mix was added to 710 mL of water where it was diluted and form a homogeneous mixture.

Step 3. When the mixture is homogeneous, 44.1 g of oils and fats mix was added.

Step 4. One or more palatability enhancers can be added to the mixture. Palatability enhancers can be in a powdered and/or liquid form. 50 g of palatability enhancer was added to the mixture.

Step 5. The whole mix obtained at Step 4 was agitated until a homogeneous blend was obtained during a time period of 5 to 10 min.

Step 6. An acid aqueous solution including 13.3 g of citric acid and 6.6 g of lactic acid and 20 mL of water was added into the mix while it is agitated at a high speed. The gel formation instantaneously occurred, and the agitation was stopped.

Step 7. The gel was placed on rest for 20 to 60 min, depending on the nature of the ingredients and the size of the batch.

Step 8. After the setting time, the gel was cut into desired shapes.

Step 9. The gel pieces were processed with an appropriate method to expulse a desired amount of liquid resulting from syneresis.

Step 10. The liquid resulting from syneresis obtained at Step 9 was collected. About 250 mL of liquid can be collected.

Step 11. The liquid obtained at Step 10 was texturized using a suitable amount of texturizing agent according to the final viscosity which is sought. The texturizing agent, 13.3 g starch was diluted into the liquid while agitated. The agitation was stopped once the resulting mixture was fully homogeneous.

Step 12. The textured liquid obtained at Step 11 was added to the gel pieces and the product was gently agitated to have a homogeneous reparation between the solid and the liquid part.

The finished product obtained at step 12 can be packaged in an appropriate container.

### Example 2: Wet Food Compositions (Qualitative and Quantitative)

The present Example provides the qualitative and quantitative composition of a wet food (“chunks and gravy” or “loaf”) in accordance with the present disclosure and as prepared in accordance with Example 1. The composition of the wet food is provided in Table 1 below.

TABLE 1
Wet Food Compositions

| Ingredients | % (w/w) |
|---|---|
| Water | 73% |
| Oils and fats | 4.41% |
| Palatability enhancer | 2 to 5% |
| Poultry meal | 10.73% |
| Cellulose | 1.84% |
| Potassium chloride | 0.12% |
| Sodium triphosphate (STPP) | 0.08% |
| Potassium sorbate | 0.30% |
| Vitamin and mineral premix | 0.40% |
| Alginate | 0.5 to 0.8% |
| Lactic acid | 0.66% |
| Citric acid | 1.33% |
| Starch | 1.5 to 2.5% |
| Total | 100.00% |

### Example 3: Microbiological Stability of Wet Foods

The present Example provides for microbiological stability testing of the wet food products prepared in accordance with present disclosure as provided in Examples 1 and 2.

A. Materials and Methods

The capacity of the wet food product according to Example 2 to resist and eliminate microbial contamination such as from C. perfringens, Salmonella, and Listeria from raw material such as poultry meal or from the environment was measured. The measurement was performed as a microbial challenge which included a simulation of a contamination of a raw material used to manufacture the jellified wet food product. A summary of the challenge methods used for (I) Salmonella; (II) Listeria monocytogenes; and (III) Clostridium perfringens is provided below.

I. Challenge Method Used for the Contamination from a Raw Material by the Germ Salmonella
Strains used (cocktail): S. Typhimurium, S. Newport, S. Senftenberg;
Preparation of the poultry meal contaminated by Salmonella (20-30 days);
Two (2) different inoculums were used in order to reach 10⁵ CFUs/g of product;
   Use of a liquid inoculum at 1% (w/w) in the product
Measure of the decontamination kinetics in the product;
   Counting: PCA (NF V ISO 4833-1) culture medium for total flora and VRBG (NF V 08-054) specific culture medium for enterobacteria. These two (2) counting allow to calculate the stress ratio of Salmonella during the trial;
   Research: Of Salmonella spp in 25 g then 125 g (Internal method: Rapid′ Salmonella);
Duration of the study: 30 days maximum post-contamination (if the targeted germ is absent before the end of this period, the study can be stopped); and
Measure of the pH at TO and at the end of the study.

II. Challenge Method Used for the Contamination from an Environmental Origin by the Germ Listeria monocytogenes
Strain used: Listeria monocytogenes;
Preparation of the Listeria strain (successive transplants in the culture medium);
One (1) type of inoculum was used in order to reach 10⁵ CFUs/g of product;
   Use of a liquid inoculum at 1% w/w in the product
Measure of the decontamination kinetics in the product;
   Counting: PCA (NF V ISO 4833-1) culture medium for total flora and OXFORD (NF EN ISO 11290-1) specific culture medium for Listeria. These two (2) counting allow to calculate the stress ratio of Listeria during the trial
   Research: Listeria in 25 g then 125 g (Internal method: ALOA One Day)
Duration of the study: 30 days maximum post-contamination (if the targeted germ is absent before the end of this period, the study can be stopped); and
Measure of the pH at TO and at the end of the study.

III. Challenge Method Used for a Natural Contamination of Dry Ingredients by the Germ Clostridium perfringens
Preparation of the strain of Clostridium perfringens on a specific growing medium;
Strain used: Clostridium perfringens;
One (1) type of inoculum has been used in order to reach 10⁵ CFUs/g of product;
   Use of a liquid inoculum at 1% w/w in the product
Measure of the decontamination kinetics in the product;
   Counting: Of Clostridium perfringens with and without spore's activation. A specific medium for Clostridium is used: TSC (NF V 08.061)-37 and 46° C.;
Duration of the study: 30 days maximum post-contamination (if the targeted germ is absent before the end of this period, the study can be stopped); and
Measure of the pH at TO and at the end of the study.

B. Results

The results of the challenge methods performed are summarized in Table 2 (Salmonella), Table 3 (Listeria) and Table 4 (Clostridium perfringens) below.

TABLE 2
Contamination by Salmonella

| | | Counting | | | | | | pH |
|---|---|---|---|---|---|---|---|---|
| | | | | Test | | Research | | Measurement |
| | | Control | | Contaminated | Liquid | | Liquid | Liquid |
| | | | Contaminated | Poultry Meal + | inoculum + | Rapid′ | Inoculum + | Inoculum + |
| | | Product | Poultry Meal | Product | Product | Salmonella | Product | Product |
| T 0 | VRBG | <10 | 2.2 × 10⁷ | <10 | 3.5 × 10⁴ | In 25 g | — | 4.12 |
| | PCA | 1.8 × 10² | 4.2 × 10⁷ | 3.8 × 10³ | 3.8 × 10⁴ | In 125 g | — | |
| T 7 h | VRBG | — | — | <10 | <10 | In 25 g | Presence | — |
| | PCA | — | — | 6.5 × 10² | 1 × 10⁴ | In 125 g | — | |
| T 24 h | VRBG | — | — | <10 | <10 | In 25 g | — | — |
| | PCA | — | — | 1.7 × 10² | 1.6 × 10² | In 125 g | — | |
| T 48 h | VRBG | — | — | — | — | In 25 g | Presence | — |
| | PCA | — | — | — | — | In 125 g | — | |
| T 72 h | VRBG | — | — | — | — | In 25 g | Absence | — |
| | PCA | — | — | — | — | In 125 g | — | |
| T 6 D | VRBG | — | — | — | — | In 25 g | — | — |
| | PCA | — | — | — | — | In 125 g | Absence | |
| T 8 D | VRBG | — | — | — | — | In 25 g | — | 4.02 |
| | PCA | — | — | — | — | In 125 g | — | |

As shown above in Table 2, the wet food product can eliminate on its own in a few hours (maximum 48 hours) a cocktail of different strains of Salmonella inoculated by dry material (such as contaminated poultry meal) or wet material (fresh cultures).

TABLE 3
Contamination by Listeria

| | | | | | | pH |
|---|---|---|---|---|---|---|
| | | Counting | | Research | | Measurement |
| | | | Test liquid | | Liquid | Liquid |
| | | Control | Inoculum + | Rapid′ | Inoculum + | Inoculum + |
| | | Product | Product | Salmonella | Product | Product |
| T 0 | OXF | <10 | 6.5 × 10⁵ | In 25 g | — | 4.10 |
| | PCA | 1.8 × 10² | 3.5 × 10⁵ | In 125 g | — | |
| T 7 h | OXF | — | 4.3 × 10⁴ | In 25 g | Presence | — |
| | PCA | — | 4.9 × 10⁴ | In 125 g | — | |
| T 24 h | OXF | — | 80 | In 25 g | — | — |
| | PCA | — | 4.5 × 10³ | In 125 g | — | |
| T 48 h | OXF | — | <10 | In 25 g | Absence | — |
| | PCA | — | 2.1 × 10² | In 125 g | — | |
| T 72 h | OXF | — | — | In 25 g | Absence | — |
| | PCA | — | — | In 125 g | — | |
| T 6 D | OXF | — | — | In 25 g | — | — |
| | PCA | — | — | In 125 g | Absence | |
| T 8 D | OXF | — | — | In 25 g | — | 3.98 |
| | PCA | — | — | In 125 g | — | |

As shown above in Table 3, the wet food product can eliminate on its own in a few hours (maximum 48 hours) a culture of Listeria monocytogenes (fresh culture).

TABLE 4
Contamination by Clostridium perfringens

| | | Vegetative form | | | | pH |
|---|---|---|---|---|---|---|
| | | counting | | Snore counting | | Measurement |
| | | | Test liquid | | Test liquid | Liquid |
| | | Control | Inoculum + | Control | Inoculum + | Inoculum + |
| | | Product | Product | Product | Product | Product |
| T 0 | TSC (37° C.) | <10 | 4 × 10⁴ | <10 | — | 4.08 |
| | TSC (46° C.) | <10 | 3.9 × 10⁴ | <10 | — | |
| T 7 h | TSC (37° C.) | — | <10 | — | <10 | — |
| | TSC (46° C.) | — | <10 | — | <10 | |
| T 24 h | TSC (37° C.) | — | <10 | — | <10 | — |
| | TSC (46° C.) | — | <10 | — | <10 | |
| T 6 D | TSC (37° C.) | — | <10 | — | <10 | 3.98 |
| | TSC (46° C.) | — | <10 | — | <10 | |

As shown above in Table 4, the wet food product can eliminate on its own in a few hours (maximum 48 hours) a culture of Clostridium perfringens (fresh culture) with or without spores.

Thus, the jellified wet food product according to the present disclosure provides an advantageous and excellent resistance to different types of bacterial contamination.

### Example 4: Palatability of Wet Foods

The present Example provides for palatability testing of wet food products prepared in accordance with the present disclosure in accordance with Example 1. The benchmark included gel-based complete wet pet foods with and without palatability enhancers and a chunk in gravy product, which is a commercial leader on the market. The following was tested: (i) a wet food product as prepared in Example 1; (ii) a wet food product as prepared in Example 1 comprising 5% w/w of the palatability enhancer A; (iii) a wet food product as prepared in Example 1 comprising 3% w/w of the palatability enhancer B; (iv) a wet food product as prepared in Example 1 comprising 2% of the palatability enhancer C; and (v) the commercially marketed wet food product. Parameters such as product prehension or ability to grip and product acceptability were tested.

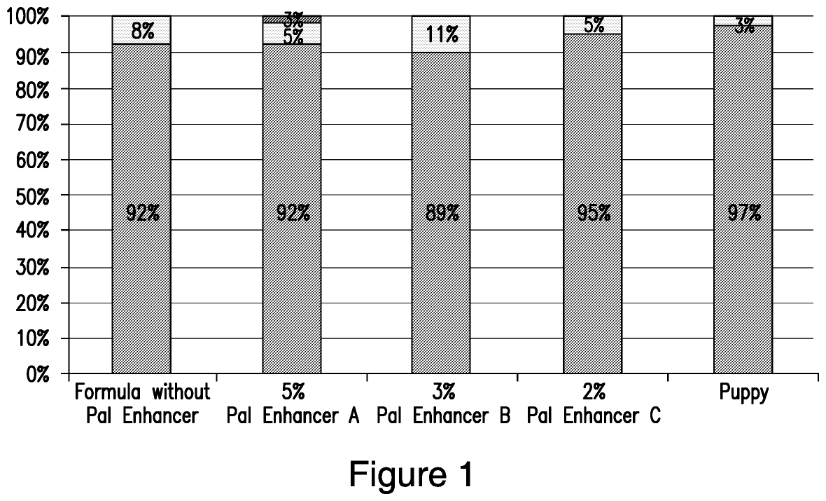

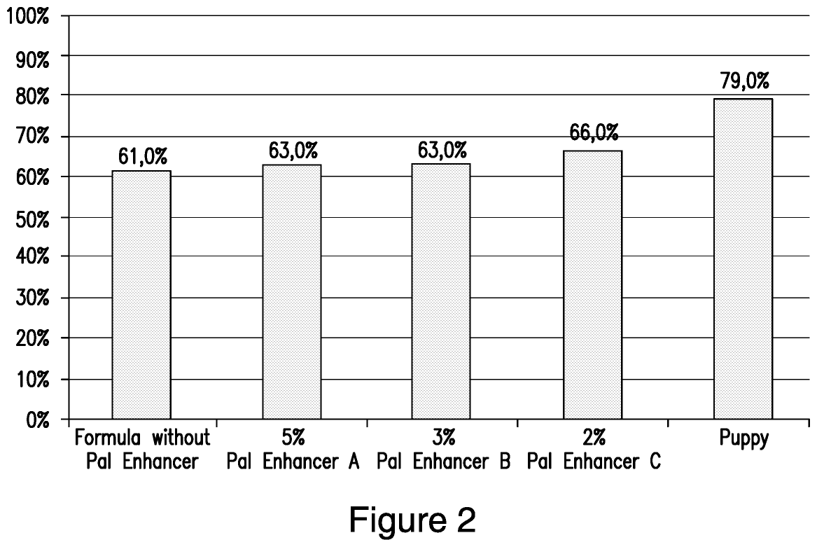

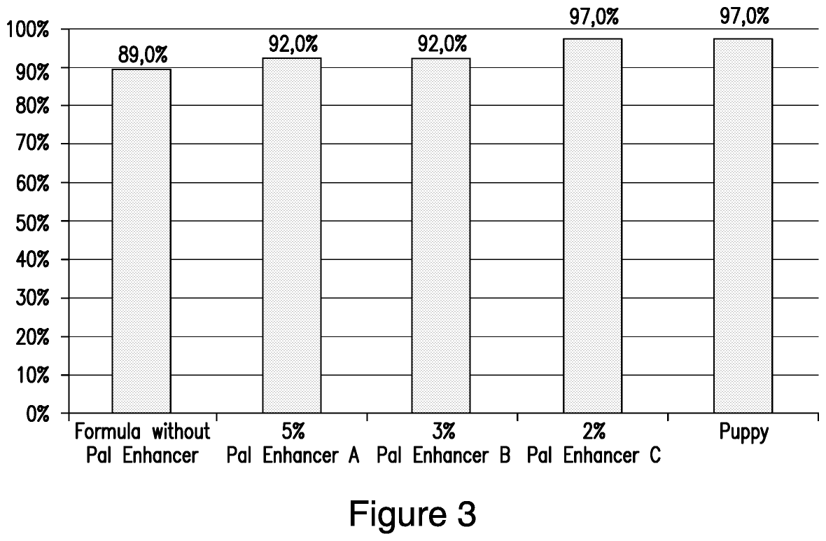

The results are provided in FIGS. 1-3. As shown in FIG. 1, there was no significant difference (p-value >5%) observed between the five (5) wet food products tested with respect to the grip ability. With respect to acceptability, as shown in FIGS. 2 and 3, there was no significant difference (p-value >5%) observed between the five (5) wet food products tested with respect to complete acceptability (FIG. 2) or 95% acceptability (FIG. 3).

The results show no significant difference in palatability between the wet food products according to the present disclosure, irrespective of whether these wet food products comprise or do not comprise a palatability enhancer.

Although the presently disclosed subject matter and its advantages have been described in detail, it should be understood that various changes, substitutions and alterations can be made herein without departing from the spirit and scope of the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

For any patents, patent applications, publications, product descriptions, and protocols are cited throughout this application, the disclosures of all of which are incorporated herein by reference in their entireties for all purposes.

1. A method for preparing a jellified wet food product, comprising:
a) preparing a pre-gel mixture comprising a combination of food ingredients, one or more alginate, and an aqueous liquid;
b) adding one or more organic acids to the pre-gel mixture to provide a jellified composition; and
c) expulsing the aqueous liquid from the jellified composition,
wherein the jellified wet food product is provided.

2. The method of claim 1, further comprising:
d) collecting the aqueous liquid expulsed at step c);
e) adding one or more thickening agents to the aqueous liquid collected at step d) to provide an aqueous material having an increased viscosity; and
f) adding the aqueous material obtained at step e) to the jellified composition obtained at the end of step c) to provide a jellified wet food product.

3. The method of claim 1, further comprising cutting the jellified composition obtained at step b) into pieces of a desired size.

4. The method of claim 1, wherein the one or more alginate comprises one or more monocation alginate.

5. The method of claim 1, wherein the one or more alginate comprises sodium alginate, potassium alginate, ammonium alginate, and combinations thereof.

6. The method of claim 1, wherein the temperature for each step of the method is less than about 40° C.

7. The method of claim 1, wherein the temperature for each step of the method is between about 10° C. and about 30° C.

8. The method of claim 1, wherein the one or more organic acids comprise Formic acid, Sorbic acid, Acetic acid, Lactic acid, Propionic acid, DL-Malic acid, Fumaric acid, Citric acid, Ascorbic acid, Phenylacetic acid, Butyric acid, 2-Methyl-2-pentenoic acid, Dec-2-enoic acid, Citronellic acid, L-Aspartic acid, L-Glutamic acid, Cinniamic acid, 2-Methylpropionic acid, 2-Methylcrotonic acid, Propionic acid, Valerie acid, 3-Methylbutyric acid, Hexanoic acid, Octanoic acid, Decanoic acid, Dodecanoic acid, Oleic acid, Hexadecanoic acid, Tetradecanoic acid, Benzoic acid, 4-Oxovaleric acid, Succinic acid, Fumaric acid, Heptanoic acid, Nonanoic acid, 2-Methylvaleric acid, 2-Ethylbutyric acid, 2-Methylbutyric acid, 2-Methylheptanoic acid, 4-Methylnonanoic acid, 4-Methyloctanoic acid, Gallic acid, Tannic acid, Glucono-delta-lactone, and combinations thereof.

9. The method of claim 1, wherein the one or more organic acids comprise Lactic acid, Citric acid, Gluconic acid, Ascorbic acid, and combinations thereof.

10. The method of claim 1, wherein at the end of step b), the jellified composition has a pH of from about 3 to about 4.6.

11. The method of claim 1, wherein at the end of step b), the jellified composition has a pH of from about 3.5 to about 4.2.

12. The method of claim 1, wherein the combination of food ingredients comprises one or more thermo-sensitive substances including vitamins, probiotics, prebiotics, protein hydrolysates, aroma, nutrients, anti-oxidants, yeast or yeast extracts, bacteria, amino acids, fibers, and combinations thereof.

13. The method of claim 1, wherein the pre-gel mixture comprises calcium at a final concentration of at least about 0.1%.

14. The method of claim 1, wherein the pre-gel mixture further comprises one or more sequestrant agents, and wherein the one or more sequestrant agents comprises pyrophosphates, orthophosphates, polyphosphates, citrates, and combinations thereof.

15. The method of claim 1, wherein the combination of food ingredients comprises protein, fat, and carbohydrates, and
wherein the protein content of the combination of food ingredients is from about 5% to about 65% by weight, on a dry matter basis.

16. The method of claim 1, wherein the method further comprises a method of preparing the pre-gel mixture, comprising:
a1) preparing a dry premix composition comprising food ingredients in fresh form, frozen form, or dehydrated form, one or more molecule of interest, and one or more alginate; and
a2) mixing the dry premix composition with an aqueous liquid,
wherein the pre-gel mixture is provided.

17. The method of claim 1, wherein the jellified wet food product is a jellified wet pet food product.

18. The method of claim 1, wherein the jellied wet food product is a jellified wet human food product.

19. A method for preparing a jellified wet food product, comprising:
a) preparing a pre-gel mixture comprising a combination of food ingredients, one or more monocation alginate, and an aqueous liquid;
b) adding one or more organic acids to the pre-gel mixture to provide a jellified composition; and
c) expulsing the aqueous liquid from the jellified composition,
wherein the jellified wet food product is provided.

20. A microbiologically stable jellified wet food product comprising protein, fat, and carbohydrates,
wherein the product has a moisture content of from about 50% to about 99%,
wherein the product further comprises alginate in an amount of from about 0.1% to about 10% by weight, on a dry matter basis, and
wherein the product has a pH of from about 3 to about 4.6.

21. The wet food product of claim 20, wherein the product has a pH of from about 3.5 to about 4.2.

22. The wet food product of claim 20, wherein the product comprises a solid portion having a gel hardness of from about 100 g to about 50,000 g and a liquid portion having a viscosity of from about 2 centipoise to about 2,000 centipoise.

23. The wet food product of claim 20, wherein the product has a protein content of from about 5% to about 65% by weight, on a dry matter basis.

24. The wet food product of claim 20, wherein the product is a jellified wet pet food.

25. A method of feeding a pet animal comprising feeding a pet with a microbiologically stable jellified wet food product obtained by the method of claim 1.

26. A method of feeding a pet animal comprising feeding a pet with a microbiologically stable jellified wet food product of claim 20.
